(19) United States
(12) Patent Application Publication
(10) Pub. No.: US 2008/0176651 A1
(43) Pub. Date: Jul. 24, 2008

(54) Gaming Machine

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/939,458

(22) Filed: Nov. 13, 2007

Related U.S. Application Data
(60) Provisional application No. 60/881,478, filed on Jan. 22, 2007.

(51) Int. Cl. A63F 13/00

(52) U.S. Cl. 463/31

(57) ABSTRACT

Each of a first game, a second game and a third game independently consists of a unit game consisting of a participation acceptable period and a game execution period, wherein a length of the participation acceptable period and a length of the game execution period are same in length among the games. The first game, the second game and the third game are displayed in a first communal display, a second communal display and the third communal display, respectively, and repeat a unit game independently. When power of a gaming machine is turned on, the first game control unit commences a first game related participation acceptable period. When a first standby period which commences at the time of power-on has terminates, the second game control unit commences a second game related participation acceptable period. Further on, when the second standby period terminates, the third game control unit commences a third game related participation acceptable period. By making the timing to commence respective games' participation acceptable periods different, there can be secured long-time chance for plural consoles to participate in each game.

### CROSS-REFERENCE TO THE RELATED APPLICATION(S)

This application is based upon and claims a priority from the U.S. provisional Patent Application No. 60/881,478 filed on Jan. 22, 2007, the entire contents thereof are incorporated herein by reference.

### BACKGROUND OF THE INVENTION

1. Field of the Invention

The present invention relates to a gaming machine wherein a plural number of players can participate in a game displayed in a communal display by using a plurality of consoles. More particularly, it relates to a gaming machine which has a plurality of communal displays and enables plural players to participate in any games displayed in the respective communal displays from each of the plurality of consoles.

2. Description of Related Art

There has conventionally been known a gaming machine which has a single communal display for displaying a game and enables plural players to participate in a game (e.g., slot game, card game such as poker and the like, roulette game, horse race game, etc.) displayed in the communal display.

For example, US Patent Application Publications No. 2005/0059474A1, No. 2005/0218590A1, and No. 2005/0282618A1 respectively disclose gaming machines each of which has a single communal display to display a game and enables plural players to participate in a game displayed in the communal display.

In the above such gaming machines, plural players participate in a game wherein a plurality of consoles are allocated to the players. Therefore, generally, there is provided a predetermined participation acceptable period before a target game is executed. That is, the gaming machine accepts each console's participation in a game (participation in a game, wagering upon an upcoming game result) during the participation acceptable period, however, closes the “participation in a game” when the participation acceptable period terminates and subsequently goes on to “game execution”. After that, the gaming machine displays the game in the communal display and awards a payout to each participant console in accordance with a game result.

### SUMMARY OF THE INVENTION

The object of the present invention is to provide a gaming machine which has convenient game management system conventional ones did not have.

Therefore, in order to achieve the object, according to a first aspect of the present invention, there is provided a gaming machine comprising: plural communal displays which display unit games each of which including an acceptable period to accept participation in a unit game and an execution period to determine and report a game result after a lapse of the acceptable period; plural consoles with which operation is carried out for a unit game displayed in any one of the plural communal displays; and a game controller programmed to operate (a) to commence acceptable periods of at least two or more of unit games executed in corresponding communal displays with different timing, (b) to process respective unit games at the plural communal displays independently and (c) to commence acceptable periods of respective next unit games after execution periods of the respective unit games at the plural communal displays terminate.

Furthermore, according to a second aspect of the present invention, there is provided a gaming machine gaming machine comprising: plural communal displays which displays unit games each of which is executed for a total necessary time including an acceptable period to accept participation in a unit game and an execution period to determine and report a game result after a lapse of the acceptable period; plural consoles with which operation is carried out for any one of unit games executed in the plural communal displays; and a game controller programmed to operate (a) to commence acceptable periods of at least two or more of unit games executed in corresponding communal displays with different timing, (b) to process respective unit games at the plural communal displays independently, and (c) to commence acceptable periods of next unit games after total necessary time, same in length, of the respective unit games at the plural communal displays terminate.

Furthermore, according to a third aspect of the present invention, there is provided a gaming machine comprising: plural communal displays which displays unit games each of which is executed for a total necessary time including an acceptable period to accept participation in a unit game and an execution period to determine and report a game result after a lapse of the acceptable period; plural consoles with which operation is carried out for any one of unit games executed in the plural communal displays; and a game controller programmed to operate (a) to set total necessary time of at least two or more of unit games executed in corresponding communal displays different in length, (b) to commence acceptable periods of respective unit games executed by the plural communal displays simultaneously, (c) to process the respective unit games at the plural communal displays independently, and (d) to commence acceptable periods of next unit games after execution periods of the respective unit games at the plural communal displays terminate.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a diagram for illustrating a feature of a gaming machine directed to the present invention;

FIG. 2 is a perspective view showing an outline construction of the gaming machine;

FIG. 3 is a perspective view showing an outline construction of a console which is one of composing elements of the gaming machine;

FIG. 4 is an exemplary block diagram illustrating a control system of the gaming machine;

FIG. 5 is an exemplary block diagram illustrating a control system of the console which is one of the composing elements of the gaming machine;

FIG. 6 is a flowchart of a main control processing program to be executed for a gaming machine of a first embodiment;

FIG. 7 is a flowchart of a communication control processing program to be executed for the gaming machine of the first embodiment;

FIG. 8 is a flowchart of a game control processing program to be executed for the gaming machine of the first embodiment;

FIG. 9 is a flowchart of a main control processing program to be executed for a console which is one of composing elements of the gaming machine of the first embodiment;

FIG. 10 is a diagram illustrating contents displayed in a liquid crystal display installed in the console;

FIG. 11 is a diagram for illustrating a feature of a gaming machine directed to a second embodiment;

FIG. 12 is a flowchart of a main control processing program to be executed for the gaming machine of the second embodiment;

FIG. 13 is a flowchart of a communication control processing program to be executed for the gaming machine of the second embodiment;

FIG. 14 is a flowchart of a main control processing program to be executed for a console which is one of composing elements of the gaming machine of the second embodiment; and

FIG. 15 is a diagram for illustrating another feature of the gaming machine directed to the second embodiment.

### DETAILED DESCRIPTION OF THE PREFERRED EMBODIMENTS

Here will be described first and second embodiments of the inventive gaming machine by referring to drawings.

A gaming machine 1 directed to both a first and second embodiment enables plural player to participate in one of three games respectively displayed in three communal displays (namely, a first communal display 21A, a second communal display 21B, and a third communal display 21C) installed in a communal display device 2 by making use of a plurality of consoles 4. During a predetermined participation acceptable period of any games, the gaming machine 1 accepts player's participation in a game and wagering operation with respect to any games displayed in the communal displays. Accordingly, in the gaming machine 1 directed to the first and second embodiments, it is only consoles 4 which have made participation operation during a participation acceptance period that can participate in any one of the three games displayed in the three communal displays.

After a participation acceptable period terminates, a target game is executed and a game result is displayed in a corresponding communal display. At this moment, a payout is awarded to each participant console 4 depending on a value wagered through the console 4 (e.g. the number of coins, medals or the like) and the game result.

When execution of the game terminates, the gaming machine 1 is programmed to commence a new participation acceptable period. That is, the gaming machine 1 directed to the first and the second embodiments is designed to: enable plural players to participate in games displayed and executed in communal displays by making use of a plurality of consoles; and repeat a unit game consisting of a participation acceptable period to accept both participation in a target game and wagering operation thereupon and a game execution period to execute the target game.

### First Embodiment

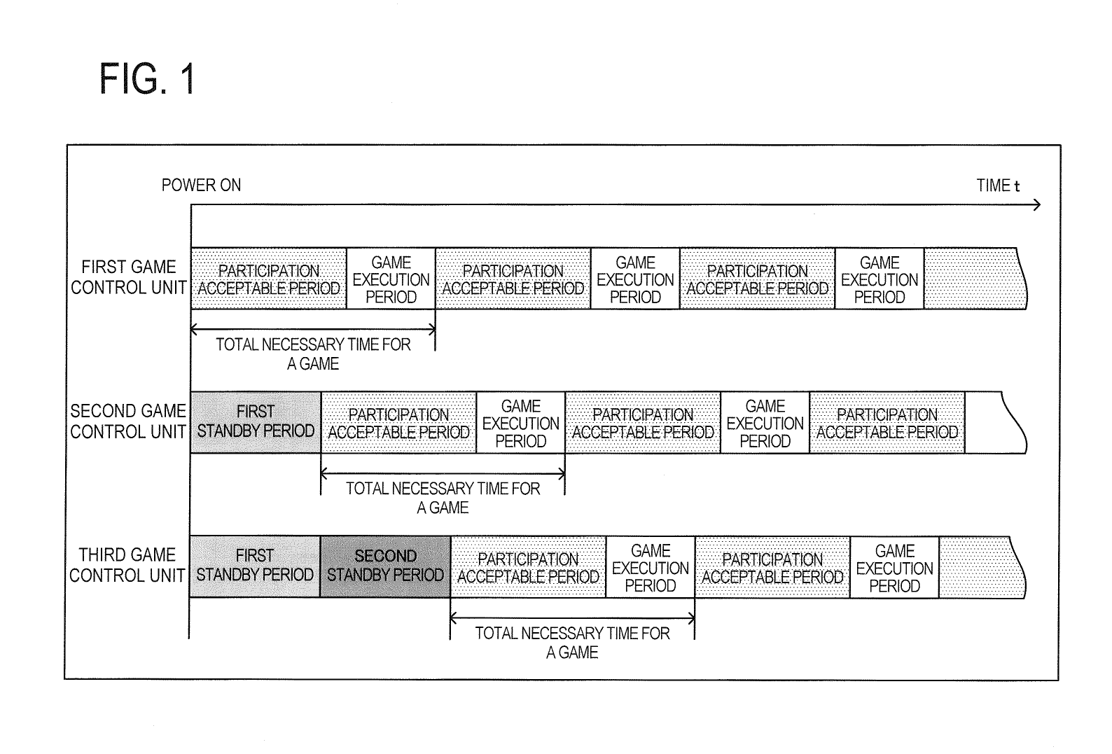

There will be described a feature of a gaming machine directed to a first embodiment by referring to drawings. FIG. 1 is a diagram for illustrating the feature of the gaming machine directed to the first embodiment.

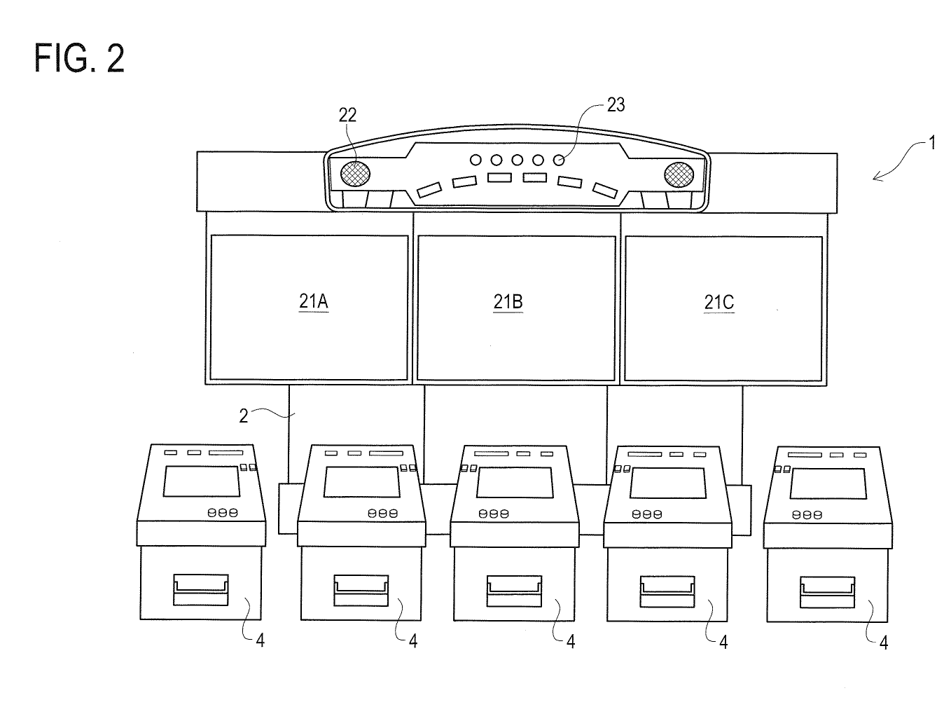

As shown in FIG. 2, a gaming machine 1 comprises a communal display device 2 and a plurality of consoles 4. In the communal display device 2, a first communal display 21A, a second communal display 21B and a third communal display 21C are installed.

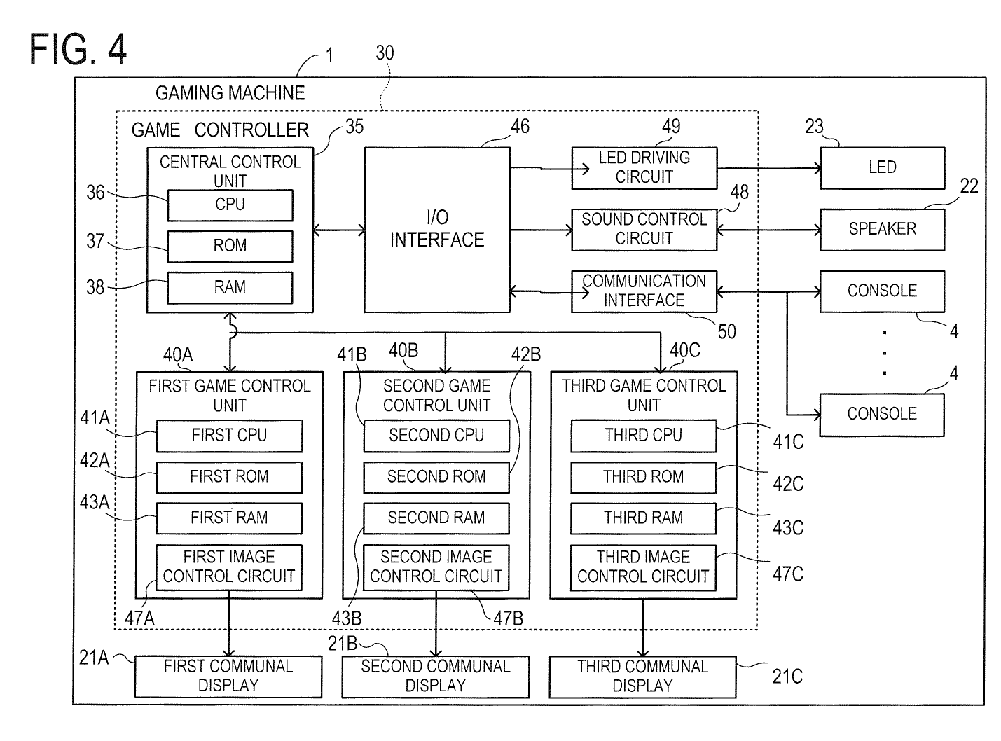

An execution of a unit game is repeated in the first communal display 21A, the second communal display 21B, and the third communal display 21C, individually. That is, a first game control unit 40A of the first communal display 21A, a second game control unit 40B of the second communal display 21B and a third game control unit 40C of the third communal display 21C, all of which will be described later and should be referred to FIG. 4, individually repeat execution of a unit game.

It is to be noted that a “first game” is a game executed by the first game control unit 40A and displayed in the first communal display 21A. Similarly, a game executed by the second game control unit 40B and displayed in the second communal display 21A is defined as a “second game”, and a game executed by the third game control unit 40C and displayed in the third communal display 21C is defined as a “third game”, herein.

As shown in FIG. 1, a unit game displayed in each of the first communal display 21A, the second communal display 21B and the third communal display 21C consists of a participation acceptable period and a game execution period. A participation acceptable period is a period for accepting both a participation in a target unit game and wagering operation upon the target game. Furthermore, a game execution period is a period for executing a series of processing to: determine a game result; report the determined game result; and award a payout depending on the game result.

In the present embodiment, a total of a participation acceptable period and a game execution period is defined as a total necessary time for a game. Since this total necessary time for a game consists of a participation acceptable period and a game execution period both belonging to a unit game, it is equal to a total necessary time for a unit game. That is, in each of the communal displays, a unit game is executed periodically along with total necessary time for a game.

In the gaming machine 1 of the first embodiment, a total necessary time for a game, a participation acceptable period and a game execution period are individually set same in length among the first game, the second game and the third game.

As shown in FIG. 1, when the power is turned on to activate the gaming machine 1 of the first embodiment, a participation acceptable period of the first game is commenced by the first game control unit 40A. At this moment, the second game and the third game have not been commenced yet by the second game control unit 40B and the third game control unit 40C, respectively, (i.e., a participation acceptable period of the second game and that of the third game have not been commenced yet), but a series of unit game related processing are withheld.

When a predetermined period (denoted as a first standby period, hereinafter) has passed since the power-on, the second game control unit 40B commences the second game (i.e., a participation acceptable period of the second game). At this moment, the first game control unit 40A is in the middle of its participation acceptable period which has been commenced in almost simultaneous with the power-on. That is, after the first standby period passes, the participation acceptable period of the first game and that of the second game overlap for a predetermined length of period (i.e., until the participation acceptable period of the first game terminates). On that account, the player can select either one of the two different games to participate in, namely, the first game or the second game, during the above-specified predetermined length of period.

At the same time when the participation acceptable period of the first game terminates, the first game control unit 40A goes on to a game execution period of the target unit game and executes a series of processing to determine and report a game result of the target unit game.

At this moment, the third game control unit 40C just stands-by without commencing a participation acceptable period of the third game.

When another predetermined period (denoted as a second standby period, hereinafter) has passed since termination of the first standby period, the third game control unit 40C commences a participation acceptable period of the third game. At this moment, the first game control unit 40A has terminated its unit game commenced at the time of power-on and commenced a new participation acceptable period of its new unit game. On the other hand, the second control unit 40B is still in the middle of its participation acceptable period which has been commenced in simultaneous with termination of the first standby period. Accordingly, a participation acceptable period of the first game, that of the second game and that of the third game overlap one another for a predetermined length period which commences after termination of the second standby period. On that account, the player can select any one of the three different game to participate in among the first game through the third game during the above-specified predetermined length of period.

After that, the first game control unit 40A, the second game control unit 40B and the third game control unit 40C execute their respective unit games individually and periodically. As described, since same length of total necessary time for a game is set for each of the first game, the second game and the third game, difference in point in time to commence a game initially set among the first game, the second game and the third game will be kept without change.

As shown in FIG. 1, commencement of a participation period of the second game is made to withhold for a first standby period and that of the third game is made to withhold for a second standby period, whereby points in time to commence the first game, the second game and the third games can be made different. Thus, there always exists at least one participation acceptable period directed to any one of the first game, the second game and the third game after the power-on. That is, according to the gaming machine 1, the player can participate in one of the three different games among the first game, the second game and the third game at any time. In other words, the gaming machine 1 has the convenience to “provide player with chances to participate in a game” constantly.

Here will be described the schematic structure of the gaming machine 1 directed to the first embodiment by referring to FIG. 2. FIG. 2 is a perspective view showing an outline construction of the gaming machine 1 directed to the first embodiment.

As shown in FIG. 2, the gaming machine 1 directed to the first embodiment comprises the communal display device 2 and a plurality of consoles 4.

The communal display device 2 is a device for displaying a game in which plural players can participate.

For example, in case of slot game, so-called simulated reels are displayed in the communal display device 2 so as to display varying symbol columns and varying-stopped symbol columns. In case of roulette game, animation images of a dealer and a roulette are displayed in the communal display device 2, and in case of card game such as poker, animation images of a dealer and dealer's cards are displayed.

As shown in FIG. 2, the communal display device 2 directed to the first embodiment comprises the first communal display 21A, the second communal display 21B and the third communal display 21C. The first communal display 21A is a liquid crystal display for displaying animations of the first game executed by the first game control unit 40A. The second communal display 21B is a liquid crystal display for displaying animations of the second game executed by the second game control unit 40B. Similarly, the third communal display 21C is a liquid crystal display for displaying animations of the third game executed by the third game control unit 40C.

As already described, the first game, the second game and the third game are processed and controlled by the first game control unit 40A, the second game control unit 40B and the third game control unit 40C, respectively and independently. Therefore, the first communal display 21A, the second communal display 21B and the third communal display 21C display their respective animations independently.

Furthermore, speakers 22, and LEDs 23 are provided at an upper portion of the communal display device 2. The speakers 22 output music and sound effects along game progress. The LEDs 23 flash in various ways for amusing effects depending on game progress.

As shown in FIG. 2, the gaming machine 1 comprises a plurality (five in the present embodiment) of consoles 4. At each console 4, an operation for any one the games among the first game, the second game and the third game is carried out by the player. Since each console 4 is arranged in front of the communal display device 2, the player seated at a console 4 can carry out operation for any one of the first game, the second game and the third game (e.g., game participation operation, wagering operation, and the like) watching contents displayed in the first communal display 21A, the second communal display 21B and the third communal display 21C.

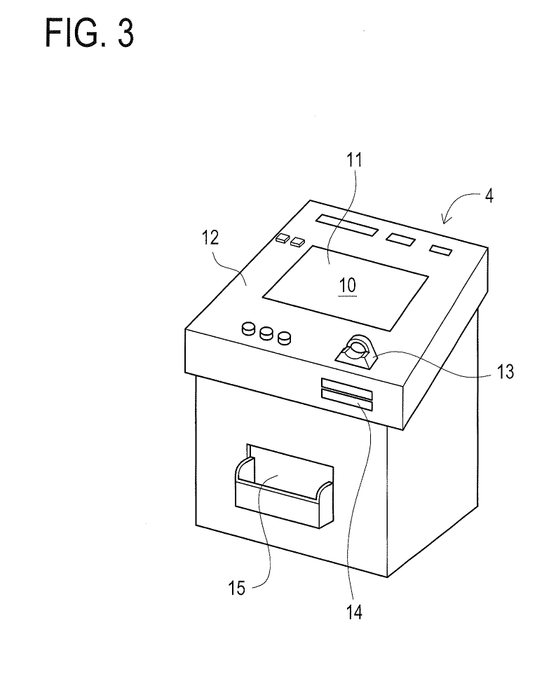

Next, a schematic structure of each console 4 will be described by referring to drawings. FIG. 3 is a view showing an outline construction of the console 4 directed to the first embodiment.

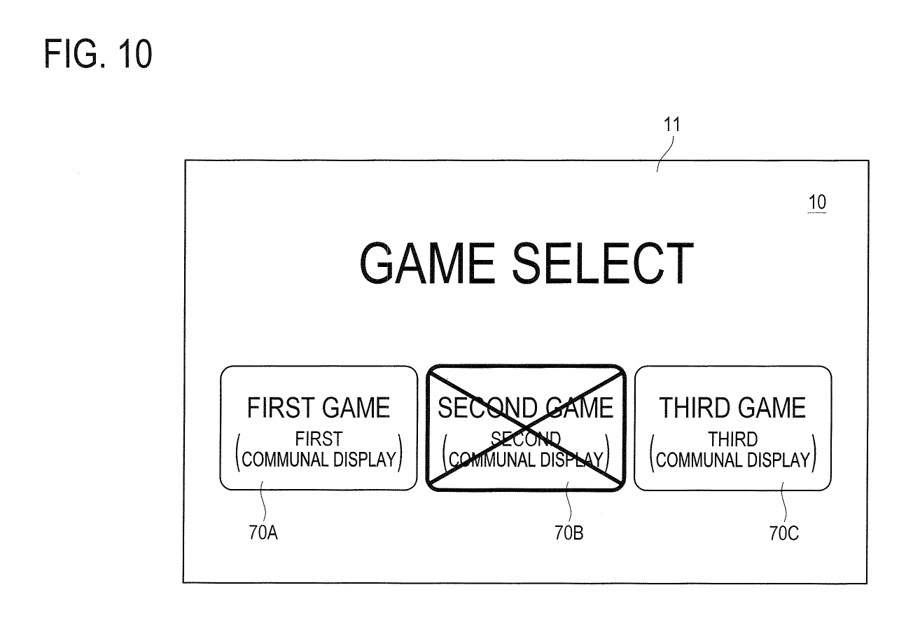

As shown in FIG. 3, the console 4 comprises a liquid crystal display 10, a touch panel 11, operation buttons 12, a coin insertion slot 13, a bill insertion slot 14, and a coin payout opening 15. The liquid crystal display 10 is mounted on an upper face of the console 4 and serves as a display device for displaying: a game selection screen (see FIG. 10) for allowing the player to select a game to participate in among the first game, the second game and the third game; a wagering screen for allowing the player to place a wagering for the game to participate in; and a game result screen. For example, in case the game selection screen (see FIG. 10) is displayed in the liquid crystal display 10 and the player gives a press on one of three selecting portions among a first game selecting portion 70A, a second game selecting portion 70B and a third game selecting portion 70C laid out in the touch panel 11, the player's press on the touch panel 11 is accepted as the operation to participate in the game the player has selected from the three selecting portions. In case the wagering screen is displayed, selection of a wagering target, setting of wagering amount can be carried out by referring to the wagering screen and touching selecting portions (for helping select a target or set a numerical value for wagering).

The operation buttons 12 are operation means for carrying out various operations such as payout operation to request a payout to be awarded to the console 4. The coin insertion slot 13 is a portion for allowing the player to insert coins or medals used as gaming value and similarly, the bill insertion slot 14 is a portion for allowing the player to insert bills. The coin payout opening 15 is a portion from which coins or medals corresponding to credits stocked in the console 4 are dispensed as payout when a payout operation is carried out with the operation buttons 12.

Next, there will be described a playing method of the gaming machine 1 directed to the first embodiment. The player who wants to play a game of the gaming machine 1 shall have a seat in front of a console 4 and carry out operation to participate in one of the three games among the first game, the second game and the third game by referring to the game selection screen (see FIG. 10) displayed in the liquid crystal display 10. After the participation operation is carried out, the wagering screen is displayed in the liquid crystal display 10. Accordingly, the player wagers a desired amount by making use of the wagering screen. It is required for the player to finish the participation operation and the wagering operation within a participation acceptable period of the selected game.

When a participation acceptable period of the game selected through the participation operation (denoted as participation target game, hereinafter) terminates, a game result of the participation target game is displayed by the communal display device 2. For example, the participation target game is slot game, varying display of a plurality of symbol columns is commenced and after a lapse of a predetermined time, the varying-stopped display of the plurality of symbol columns is sequentially carried out. After that, a payout is awarded to the console 4 in accordance with wagered contents reflecting the wagering operation and game result of the participation target game.

Next, there will be described a control system structure of the gaming machine 1 directed to the first embodiment by referring to drawings. FIG. 4 is an exemplary block diagram illustrating the control system of the gaming machine 1 directed to the first embodiment.

As shown in FIG. 4, the gaming machine 1 comprises a game controller 30, the plurality of consoles 4, the first communal display 21A, the second communal display 21B, the third communal display 21C, and various peripheral devices.

The game controller 30 essentially comprises a central control unit 35, the first game control unit 40A, the second game control unit 40B, and the third game control unit 40C.

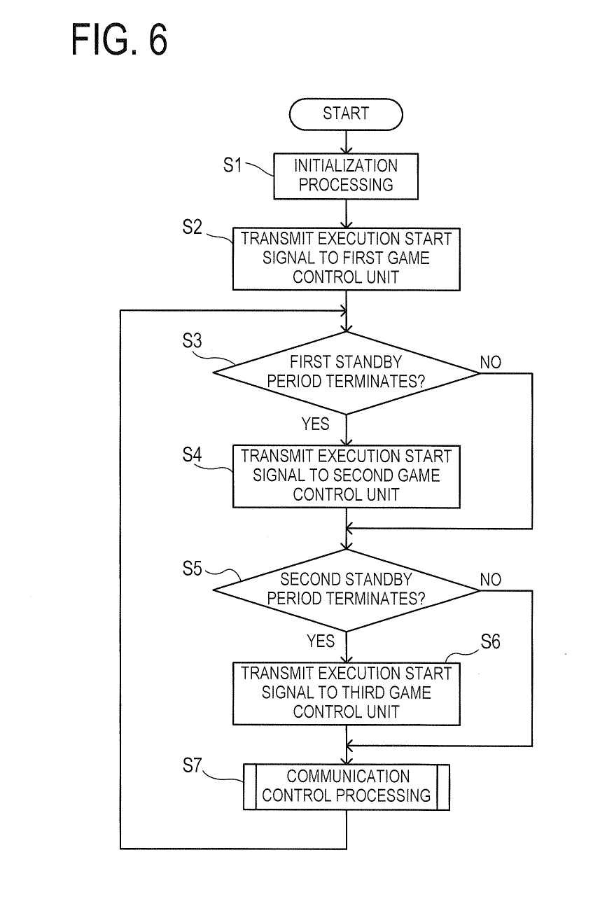

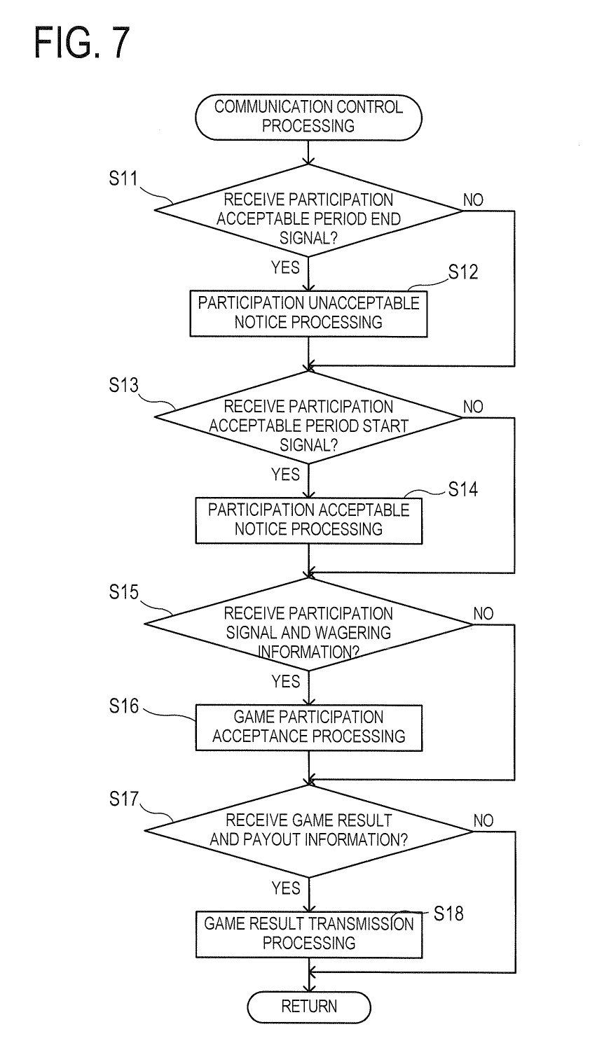

The central control unit 35 is a control unit for controlling the entirety of the gaming machine 1. To be more specific, the central control unit 35 executes control processing such as data communication control of each of the consoles 4. The central control unit 35 consists of a CPU 36, a ROM 37, and a RAM 38. The ROM 37 stores various programs for executing processing required to control the entirety of the gaming machine 1, data tables and the like. That is, in the ROM 37, there are stored a main control program (see FIG. 6), a communication control program (see FIG. 7), both of which will be described later, and such like various programs. The CPU 36 is a processing unit for executing various control programs and serves as the nerve center of control under the central control unit 35. The RAM 38 is a memory for temporarily storing various data processed by the CPU 36.

The central control unit 35 is connected to a sound control circuit 48, an LED driving circuit 49 and a communication interface 50 through an I/O interface 46. The sound control circuit 48 is connected to the speakers 22, whereby the speakers 22 are controlled to output predetermined music and sound effects in accordance with control of the game controller 30. The LED driving circuit 49 is connected to the LEDs 23, whereby flashing manner of the LEDs 23 as game effects are changed depending on game progress in accordance with control of the game controller 30.

The communication interface 50 is connected to a communication interface 61 of each console 4 which constitute a part of the gaming machine 1. That is, the communication interface 50 is an interface for transmitting data and signals between the central control unit 35 and each console 4.

As shown in FIG. 4, the first game control unit 40A, the second game control unit 40B and the third game control unit 40C are connected to the central control unit 35 through bas lines. As described, the first game control unit 40C, the second game control unit 40B and the third game control unit 40C are control portions for controlling the first game, the second game and the third game displayed in the first communal display 21A, the second communal display 21B and the third communal display 21C, respectively.

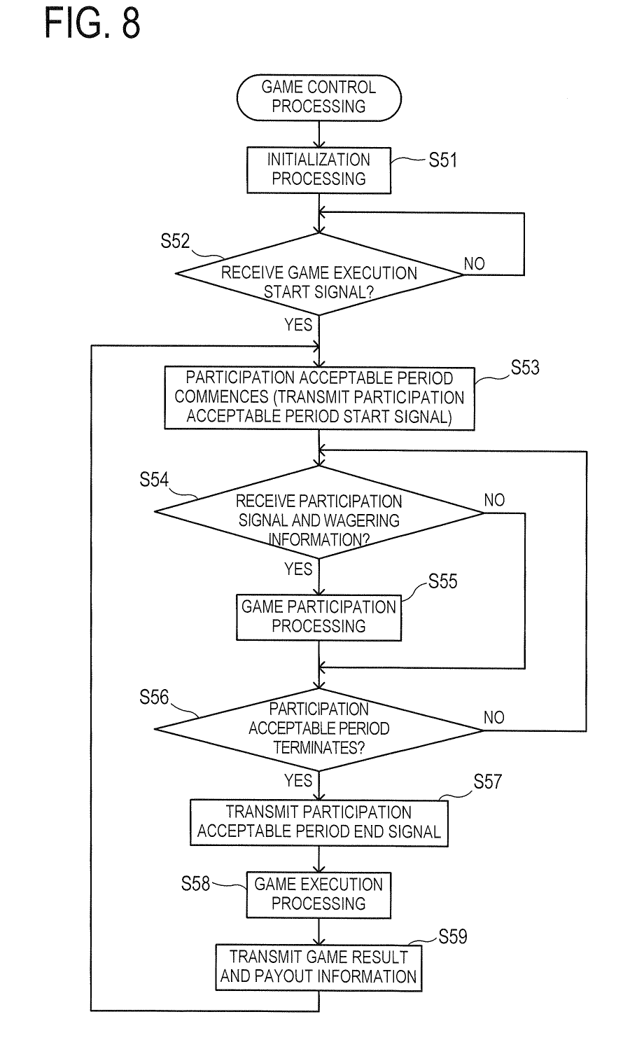

The first game control unit 40A comprises a first CPU 41A, a first ROM 42A, a first RAM 43A and a first image control circuit 47A. In the first ROM 42A, there are stored various control programs for executing the first game, data tables and the like. Accordingly, in the first ROM 42A, there is stored a game control processing program for the first game (see FIG. 8). The first CPU 41A is a processing unit which reads out the control program from the first ROM 42A and executes the program. Accordingly, the first CPU 41A carries out first-game-related control at the gaming machine 1 by executing the first-game-related game control program. The first RAM 43A is a memory for temporarily storing various data processed by the first CPU 41A.

The first image control circuit 47A is a control circuit for displaying images in the first communal display 21A in accordance with processing result of the first CPU 41A. Thereby, image display in the first communal display 21A is varied any time along game progress of the first game.

The second game control unit 40B comprises a second CPU 41B, a second ROM 42B, a second RAM 43B and a second image control circuit 47B. Various devices constituting the second game control unit 40B are structurally same as the ones constituting the first game control unit 40A except a point that control for displaying the second game in the second communal display 21B is conducted there. Accordingly, there will be omitted a detailed description on the various devices constituting the second game control unit 40B.

The third game control unit 40C comprises a third CPU 41C, a third ROM 42C, a third RAM 43C and a third image control circuit 47C. Similarly, various devices constituting the third game control unit 40C are structurally same as the ones constituting the first game control unit 40A except a point that control for displaying the third game in the third communal display 21C is conducted there. Accordingly, there will be omitted a detailed description on the various devices constituting the third game control unit 40C.

It is to be noted that the first game control unit 40A, the second game control unit 40B and the third game control unit 40C are collectively denoted as “game control units 40” in the specification.

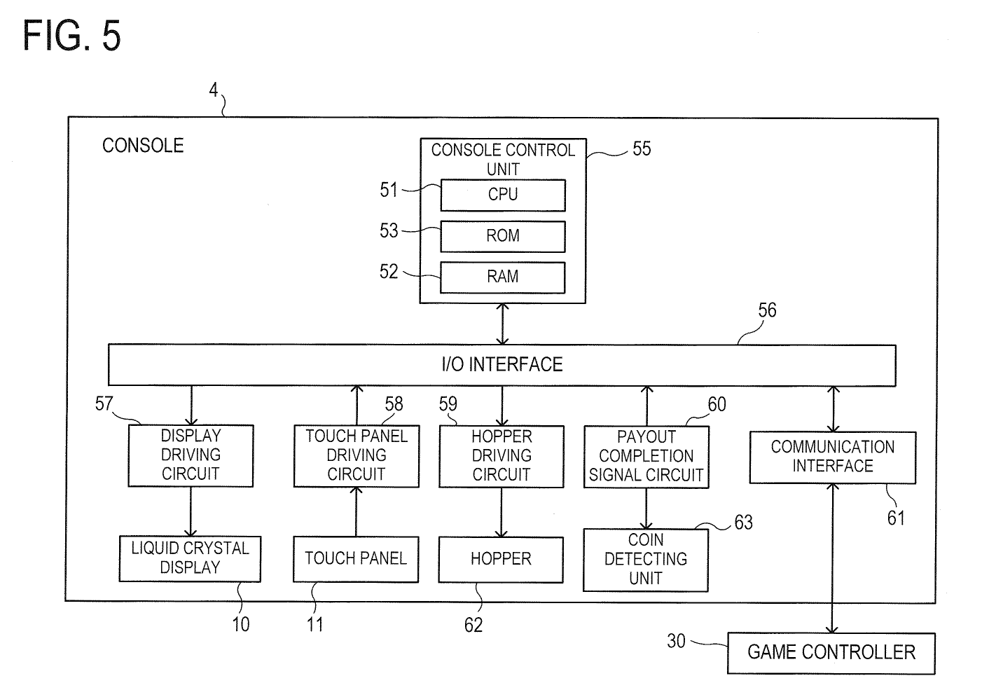

Next, there will be described a control system of each console 4 which constitutes a part of the gaming machine 1 by referring to drawings. FIG. 5 is an exemplary diagram illustrating the control system of the console 4.

As shown in FIG. 5, the control system of the console 4 comprises a console control unit 55 which is essential to the system. The console control unit 55 comprises a CPU 51, RAM 52 and ROM 53.

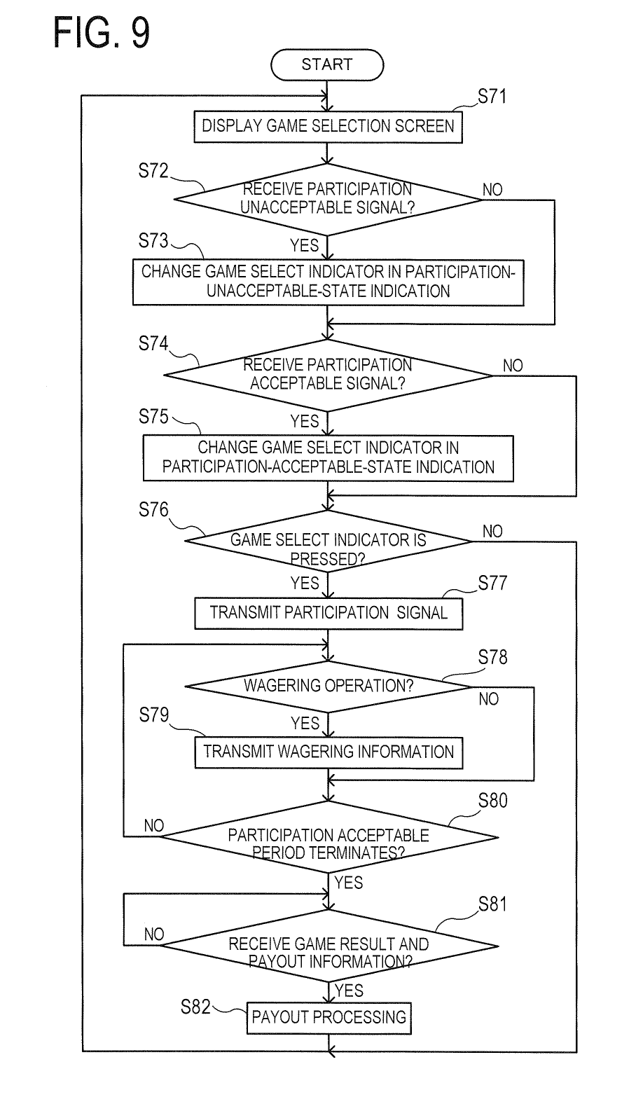

The ROM 53 stores various programs for executing processing required to control the console 4, data tables and the like. That is, the ROM 53 stores a main control program of the console 4 (see FIG. 9) and such like various programs.

The CPU 51 is a processing unit for executing a control program stored in the ROM 53. That is, the CPU 51 serves as the nerve center of control relating to game select processing among the first game the second game and the third game, wagering processing and the like.

The RAM 52 is a memory for temporarily storing various data processed by the CPU 51, namely, the number of credits currently stocked in the console 4, a wagering target placed by the player, amount of wagering (the number of credits) wagered upon the wagering target and the like.

The console control unit 55 is connected to a display driving circuit 57, a touch panel driving circuit 58, a hopper driving circuit 59, a payout completion signal circuit 60 and a communication interface 61 through an I/O interface 56.

The display driving circuit 57 is connected to a liquid crystal display 10 installed in the console 4. That is, the display driving circuit 57 is a circuit for executing display control of the liquid crystal display 10. Accordingly, what is displayed in the liquid crystal display 10 is controlled by the display driving circuit 57.

The touch panel driving circuit 58 is connected to a touch panel 11 provided on a front face of the liquid crystal display 10. That is, the touch panel driving circuit 58 is a circuit for transmitting an operation signal to the console control unit 55 when operation on the touch panel 11 is made. Thereby, the console control unit 55 can detect operation made on the touch panel 11 in case a game selection screen and a wagering screen are displayed in the liquid display 10.

The hopper driving circuit 59 is connected to a hopper 62. That is, the hopper driving circuit 59 is a circuit for controlling driving manner of the hopper 62 in accordance with a control signal from the console control unit 55. The payout completion signal circuit 60 is connected to a coin detecting unit 63. That is, the payout completion signal circuit 60 is a circuit for transmitting a payout completion signal to the console control unit 55 when coins to be paid out to the coin payout opening 15 is detected by the coin detecting unit 63 and predetermined amount of coins is detected. Accordingly, at the console 4, predetermined amount of coin depending on game result can be paid out in accordance with operation with the operation buttons 12.

The communication interface 61 is connected to the game controller 30. That is, the communication interface 61 is connected to the communication interface 50 of the game controller 30. Since the communication interface 50 is connected to the central control unit 35, as described, the communication interface 61 transmits data and signals to the console 4 and the central control unit 35.

Next, there will be described various control programs to be executed for the gaming machine 1 directed to the first embodiment by referring to drawings.

Firstly, there will be described a main control program to be executed by the central control unit 35 of the gaming machine 1. FIG. 6 is a flowchart of the main control program for the entirety of the gaming machine 1.

As shown in FIG. 6, when the power of the gaming machine 1 is turned on, the central control unit 35 firstly carries out an initialization processing (S1). At the initialization processing (S1), there is carried out processing to initialize contents stored in the central control unit 35, various peripheral devices and the like. The central control unit 35 transmits an initialization signal to each of the game control units 40, namely, the first game control unit 40A, the second game control unit 40B and the third game control unit 40C. In response to the initialization signals, each of the game control units 40 carries out a predetermined initialization processing (S51) and goes on to its standby state. After termination of the initialization processing (S1), the central control unit 35 goes on to a processing at S2.

Going on to S2, the central control unit 35 transmits an “execution start signal” to the first game control unit 40A through the bus line so as to commence an execution of the first game. This “execution start signal” is a signal to make each of the game control units 40 commence a corresponding game. Accordingly, upon receipt of an “execution start signal” transmitted at S2, the first game control unit 40A commences a processing for executing the first game (S53). In this connection, control processing of the first game control unit 40A will be described in detail later by referring to drawings.

After transmitting the “execution start signal” to the first control unit 40A, the central control unit 35 goes on to a processing at S3.

At S3, the central control unit 35 judges whether or not a first standby period (see FIG. 1) has terminated. The central control unit 35 judges the termination of the first standby period in accordance with a clock circuit installed in the central control unit 35. This clock circuit is activated while the power of the gaming machine 1 is being supplied. In case the first standby period has terminated (S3: YES), the central control unit 35 goes on to a processing at S4. In case the first standby period has not yet terminated (S3: NO), the central control unit 35 goes on to a processing at S5.

After the first standby period terminates (S3: YES) the central control unit 35 transmits an “execution start signal” to the second game control unit 40B (S4). Upon receipt of the “execution start signal”, the second game control unit 40B resets the standby state and commences a processing for executing the second game (S53). In this connection, control processing of the second game control unit 40B will be described in detail later by referring to drawings.

After transmitting an “execution start signal” to the second control unit 40B, the central control unit 35 goes on to a processing at S5.

Going on to S5, the central control unit 35 judges whether or not a second standby period (see FIG. 1) has terminated. To be more specific, the central control unit 35 judges the termination of the second standby period in accordance with the clock circuit. In case the second standby period has terminated (S5: YES), the central control unit 35 goes on to a processing at S6. In case the second standby period has not yet terminated (S5: NO), the central control unit 35 goes on to a processing at S7.

After the second standby period terminates (S5: YES), the central control unit 35 transmits an “execution start signal” to the third game control unit 40C (S6). Upon receipt of the “execution start signal”, the third game control unit 40C resets the standby state and commences a processing for executing the third game (S53). In this connection, control processing of the third game control unit 40C will be described in detail later by referring to drawings.

After transmitting an “execution start signal” to the third control unit 40C, the central control unit 35 goes on to a processing at S7.

Going on to S7, the central control unit 35 carries out a communication control processing. At the communication control processing (S7), various signals and data transmitted from the game control units 40 are transmitted to each of the target consoles 4, and vice versa, various signals and data transmitted from each of the consoles 4 are transmitted to each corresponding target game unit 40. In this connection, the communication control processing will be described in detail later by referring to drawings.

After finishing the communication control processing (S7), the central control unit 35 returns to the processing at S3. That is, the central control unit 35 repeats a series of the processing S3 through S7 constantly, thereafter.

Next, there will be described a communication control processing program to be executed at S7 in detail by referring to drawings. FIG. 7 is a flowchart of the communication control processing program.

As shown in FIG. 7, going on to the communication control processing (S7), the central control unit 35 judges whether or not to have received a “participation acceptable period end signal” transmitted from a certain game control unit 40 (S11). The “participation acceptable period end signal” is a signal to be transmitted to the central control unit 35 at S57, namely, a game control processing program to be described later, and also a signal for indicating an end of a participation acceptable period for a certain game. In case of having received a “participation acceptable period end signal” (S11: YES), the central control unit 35 goes on to a participation unacceptable notice processing (S12). In case of having not received a “participation acceptable period end signal” (S11: NO), the central control unit 35 goes on to a processing at S13.

At the participation unacceptable notice processing (S12), the central control unit 35 transmits each console 4 a “participation unacceptable signal” in response to the participation acceptable period end signal the central control unit 35 has received.

The “participation unacceptable signal” is a signal for indicating that a participation acceptable period of a game has terminated. In this regard, since it is possible to specify a game control unit 40 which has transmitted a “participation acceptable period end signal” at the participation unacceptable notice processing, it makes it possible for the player to specify game(s) currently unacceptable to participate in. Thereby, information concerning “game(s) currently unacceptable for players to participate in” can be added to a “participation unacceptable signal”. As a result, each console 4 in receipt of the “participation unacceptable signal” changes its display contents of the game selection screen (see FIG. 10) to a selection unacceptable state (denoted as participation unacceptable indication, hereinafter) with respect to a “game currently unacceptable to participate in” (S73).

After transmitting a “participation unacceptable signal” to each console 4, the central control unit 35 goes on to a processing at S13.

At S13, the central control unit 35 judges whether or not to have received a “participation acceptable period start signal” transmitted from a certain control unit 40. The “participation acceptable period start signal” is a signal to be transmitted to the central control unit 35 at S53, namely, a game control processing program to be described later, and also a signal for indicating a start of a participation acceptable period for a certain game. In case of having received a “participation acceptable period start signal” (S13: YES), the central control unit 35 goes on to a participation acceptable notice processing (S14). In case of having not received a “participation acceptable period start signal” (S13: NO), the central control unit 35 goes on to a processing at S15.

Going on to the participation acceptable notice processing (S14), the central control unit 35 transmits each console 4 a “participation acceptable signal” in response to the participation acceptable period start signal the central control unit 35 has received.

The “participation acceptable signal” is a signal for indicating that a participation acceptable period a game has commenced. In this regard, similar to the participation unacceptable notice processing (S12), specifying a game control unit 40 which has transmitted a “participation acceptable period start signal”, it makes it possible to specify a game of which participation acceptable period has been commenced. Thereby, information concerning a “game currently acceptable to participate in” can be added to a “participation acceptable signal”. As a result, each console 4 in receipt of the “participation acceptable signal” changes its display contents of the game selection screen (see FIG. 10) to a selection acceptable state (denoted as participation acceptable indication, hereinafter) with respect to a “game currently acceptable to participate in” (S75).

After transmitting a “participation acceptable signal” to each console 4, the central control unit 35 goes on to a processing at S15.

In the present embodiment, a “participation acceptable signal” and a “participation unacceptable signal” are transmitted to each of the consoles 4. However, these signals may be transmitted to only a console 4 which has not participated in a game.

At S15, the central control unit 35 judges whether or not to have received a “participation signal” and “wagering information” from a console 4. The “participation signal” is a signal transmitted in response to a selection operation to touch one of three selection indicators, namely, a first game selecting indicator 70A, a second game selecting indicator 70B, and a third game selecting indicator 70C, and also a signal for indicating which game the target console 4 participates in among the first game, the second game and the third game. The “wagering information” indicates information concerning “wagering contents of a player”. In case of receiving a “participation signal” and “wagering information” (S15: YES), the central control unit 35 goes on to a processing at S16. In case of not receiving a “participation signal” and “wagering information” (S15: NO), the central control unit 35 goes on to a processing at S17.

At S16, the central control unit 35 carries out a game participation acceptance processing. At the game participation acceptance processing (S16), the central control unit 35 carries out a processing to transmit a “participation signal” and “wagering information”, both of which the game control unit 35 has received, to a target game control unit 40 together with an identification signal of the target console 4. Thereby, there is settled the target console 4's “participation in a game”. After terminating the game participation acceptance processing (S16), the central control unit 35 goes on to a processing at S17.

At S17, the central control unit 35 judges whether or not to have received “game result” and “payout information”. The “game result” is information about an executed game result, and the “payout information” is data indicating payout contents in accordance with the game result. Both the “game result” and “payout information” are data transmitted from the game control units 40. In case of receiving “game result” and “payout information” (S17: YES), the central control unit 35 goes on to a game result transmission processing (S18). In case of not receiving “game result” and “payout information” (S17: NO), the central control unit 35 terminates the communication control processing program and returns to the main control program.

At the game result transmission processing (S18), the central control unit 35 transmits the “game result” and “payout information”, the central control unit 35 has received, to consoles 4 which have participated in the target game. Thereby, the participant consoles 4 can obtain the “game result” and “payout information” about the target game. Accordingly, the players who have participated in a game with their respective consoles 4 can obtain prize in accordance with the game result by operating the operation buttons 12 or the like.

After carrying out the game result transmission processing (S18), the central control unit 35 terminates the communication control processing program and returns to the main control program.

Next, there will be described a game control processing program to be executed by each game control unit 40 by referring to drawings. FIG. 8 is a flowchart of the game control processing program.

It is be noted that the game control processing program is independently executed by each of the game control units 40, namely, the first game control unit 40A, the second game control unit 40B and the third game control unit 40C. Except a game execution processing (S58) to be described later, each game control processing program to be executed by each of the game control units 40 is same in terms of essential structure.

As described, when the power of the gaming machine 1 is turned on, the central control unit 35 transmits an initialization signal to each of the game control units 40 at the initialization processing (S1).

As shown in FIG. 8, each of the game control units 40 carries out a processing to initialize contents stored in each of their RAMs constituting the central control unit 35 (namely, the first RAM 43A, the second RAM 43B and the third RAM 43C) in accordance with the initialization signal. When the initialization processing (S51) terminates, the game control units 40 are settled in a standby state in which it is ready for executing a game, and go on to a processing at S52.

At S52, each of the game control units 40 judges whether or not to have received a “game execution start signal” from the central control unit 35. In case of receiving the “game execution start signal” (S52: YES), a target game control unit 40 goes on to a processing at S53. In case of not receiving the “game execution start signal” (S52: NO), the target game control unit 40 returns to the processing at S52. That is, each of the game control units 40 keeps standby state until receiving each of their “game execution start signal”.

In case of receiving the “game execution start signal” (S52: YES), the target game control unit 40 commences a participation acceptable period of a unit game directed to the target game control unit 40 (S53). At this moment, the target game control unit 40 transmits the central control unit 35 a “participation acceptable period start signal”. For example, in case the second game control unit 40B receives a “game execution start signal” (S52: YES), the second game control unit 40B commences a participation acceptable period of a unit game directed to the second game. Further on, the second game control unit 40B transmits the central control unit 35 a “second game related participation acceptable period start signal” (S53).

After commencing the participation acceptable period, the target control unit 40 goes on to a processing at S54.

At S54, the game control unit 40 judges whether or not to have received a “participation signal” and “wagering information” from the central control unit 35. As described, in case the central control unit 35 has received a “participation signal” and “wagering information” along participation operation and wagering operation, respectively, done at each console 4 (S15: YES), the central control unit 35 transmits the “participation signal” and “wagering information” to a corresponding game control unit 40 (S16). That is, at S54, the corresponding game control unit 40 judges whether or not to have received the “participation signal” and “wagering information” transmitted at S16. In case of receiving the “participation signal” and “wagering information” (S54: YES), the corresponding game control unit 40 goes on to a game participation processing (S55). In case of not receiving the “participation signal” and “wagering information” (S54: NO), the corresponding game control unit 40 goes on to a processing at S56.

At S55, the game control unit 40 carries out the game participation processing. The game participation processing (S55) is a processing to accept and verify that the target console 4 which has transmitted the “participation signal” and “wagering information” should participate in a game to be executed by the target game control unit 40. For example, in case the second game control unit 40B has received a “participation signal” and “wagering information”, the second game control unit 40B accepts that a console 4 which has transmitted a “participation signal” and “wagering information” to the second game control unit 40B should participation in a second-game related unit game, and verifies the participation.

After storing each “participation signal” and “wagering information” transmitted from each console 4 in the corresponding RAM (first RAM 43A, second RAM 43B and third RAM 43C), the target game control unit 40 goes on to a processing at S56.

At S56, the target game control unit 40 judges whether or not a participation acceptable period of the target unit game has terminated. The judgment at S56 is made by referring to a clock circuit installed in the target game control unit 40. In case the participation acceptable period has terminated (S56: YES), the target game control unit 40 goes on to a processing at S57. In case the participation acceptable period has not terminated (S56: NO), the target game control unit 40 returns to the processing at S54. Since a series of processing S54 through S56 is repeated, the target game control unit 40 can accept a “participation signal” and “wagering information” from other console 4 then.

At S57, the target game control unit 40 transmits the central control unit 35 a “participation acceptable period end signal”. For example, in case a participation acceptable period with respect to the second game control unit 40B has been terminated (S56: YES), the second game control unit 40B transmits a “participation acceptable period end signal” which indicates a lapse of a participation acceptable period with respect to the second game (S57). After transmitting the “participation acceptable period end signal”, the target game control unit 40 goes on to a processing at S58.

It is to be noted that a series of processing S53 through S57 is executed only while a “participation acceptable period”. In the gaming machine 1 directed to the first embodiment, the length of a participation acceptable period of each game, namely, the first game, the second game and the third game, is same (see FIG. 1).

At S58, the target game control unit 40 executes a game execution processing. At the game execution processing, the target game control unit 40 determines a game result by a lottery and further executes a processing to report the game result. Furthermore, the target game control unit 40 executes a processing to determine contents of prize to be awarded to a console 4 which participated in the target game in accordance with the determined game result. Since the above-mentioned kinds of processing have been well-known, detailed description of them will be omitted.

After terminating the game execution processing (S58), the target control unit 40 goes on to a processing at S59.

For example, in case “slot game” is executed as the second game, the second game control unit 40B determines a symbols to be stopped and displayed in each reel by a lottery at the game execution processing (S58). Further on, the second game control unit 40B carries out spinning symbol display in the second communal display 21B through the second image control circuit 47B and reports each determined symbol as a game result. Also, the second game control unit 40B determines contents of prize to be awarded to a console 4 which participated in the second game in accordance with a payout table (not shown).

It is to be noted that this game execution processing (S58) is executed for a period same in length at any of the first game control unit 40A, the second game control unit 40B and the third game control unit 40C. That is, at a game execution processing (S58) directed to any of the first game, the second game and the third game, determination and report of game result and determination of prize contents in accordance with the game result may be carried out within a predetermined length of a game execution period. Accordingly, kinds of game to be executed as the first game, the second game and the third game do not matter.

To be more specific, “slot game” is applied as the second game in the above-mentioned example. However, “slot game” is also applicable to both the first game and the third game, or other than that, it is also possible to set such like “card game such as poker and the like” for the first game and “roulette game” or “horse race game” for the third game.

At S59, the target game control unit 40 transmits the central control unit 35 the “game result” determined at the game execution processing (S58) and “payout information” of each console 4 determined in accordance with the game result. After transmitting the “game result” and “payout information”, the game control unit 40 returns to the processing at S53. That is, the target game control unit 40 executes a series of processing S58 and S59 within a game execution period shown in FIG. 1.

The target game control unit 40 returns to the processing at S53 immediately after finishing the processing at S59. Therefore, at the target game control unit 40, a participation acceptable period of a new unit game commences immediately after a termination of a game execution period of a preceding unit game.

As described previously, the game control processing program is executed by any of the first game control unit 40A, the second game control unit 40B and the third game control unit 40C, independently. In the game control processing program, a participation acceptable period is not commenced until the target game control unit 40 receives a “game execution start signal” (S52: YES). That is, in the main control program of the central control unit 35, a “game execution start signal” is transmitted to the second game control unit 40B and the third game control unit 40C separately on condition that a first standby period and a second standby period have terminated so that timing to commence a unit game of the first game, that of the second game and that of the third game (i.e., commencement timing of their respective participation acceptable periods) should be made different to one another (see FIG. 1).

Next, there will be described a main control processing program to be executed by each console 4 in detail by referring to drawings. FIG. 9 is a flowchart of the main control processing program of the console 4.

As shown in FIG. 9, when the power of the gaming machine 1 is turned on, the console control unit 55 firstly causes the liquid crystal display 10 to display a game selection screen (see FIG. 10) through the display driving circuit 57 (S71). After that, the console control unit 55 goes on to a processing at S72.

There will be described the game selection screen to be displayed in the liquid crystal display 10 in detail by referring to drawings. FIG. 10 is a diagram exemplary indicating the game selection screen.

As shown in FIG. 10, when the game selection screen is displayed, there are displayed the first game selecting indicator 70A the second game selecting indicator 70B and the third game selecting indicator 70C in the liquid crystal display 10. The first game selector indicator 70A is a selecting indicator directed to the first game to be displayed in the first communal display 21A. The second game selector indicator 70B is a selecting indicator directed to the second game to be displayed in the second communal display 21B. The third game selector indicator 70C is a selecting indicator directed to the second game to be displayed in the third communal display 21B.

As described in the above, since the touch panels 11 are provided on a front face of the liquid crystal display 10, touch panels 11 corresponding to the first game selecting indicator 70A, the second game selecting indicator 70B and the third game selecting indicator 70C, respectively, can be operated by pressing their respective corresponding locations. Thereby, the player can select one of the games among the first game, the second game and the third game and carry out operation to participate in the desired game.

For example, in case the player wishes to participate in the first game and gives a press onto touch panel 11 directed to the first game selecting indicator 70A, a “participation signal” indicating participation in the first game is transmitted to the central control unit 35 from the target console 4 (S77). The “participation signal” transmitted to the central control unit 35 is further transmitted to the first game control unit 40A (S16). The first game control unit 40A accepts that the target console 4 should participate in the first game by executing the game participation processing (S55) in accordance with the target “participation signal”.

Reverting to FIG. 9, there will be described a main control processing program to be executed by the console control unit 55. At S72, the console control unit 55 judges whether or not to have received a “participation unacceptable signal” from the central control unit 35. In case of receiving a “participation unacceptable signal” (S72: YES), the console control unit 55 changes indication state of the game selecting indicator directed to the target “participation unacceptable signal” to participation-unacceptable-state indication (S73). At this moment, the console control unit 55 sets a player's press on the target game selecting indicator of the corresponding touch panel 11 “invalid”. After changing indication of the target game selecting indicator to participation-unacceptable-state indication, the console control unit 55 goes on to a processing at S74.

In case of not receiving a “participation unacceptable signal” (S72: NO), the console control unit 55 goes on to a processing at S74.

To be more specific, upon receiving a “participation unacceptable signal” from the second game control unit 40B, the console control unit 55 changes indication color of the second game selecting indicator 70B directed to the second game and adds a sign for indicating a participation-unacceptable state to the second game selecting indicator 70B. As shown in FIG. 10, by changing indication of a game selecting indicator to participation-unacceptable state indication, the player can grasp “which game is unacceptable to participate in” unquestionably.

At S74, the console control unit 55 judges whether or not to have received a “participation acceptable signal” from the central control unit 35. In case of receiving a “participation acceptable signal”, the console control unit 55 changes indication of the game selecting indicator directed to the target “participation acceptable signal” to participation-acceptable-state indication (S75). At this moment, the console control unit 55 sets a player's press on the target game selecting indicator of the corresponding touch panel 11 “valid”.

In the first embodiment, the participation-acceptable-state indication corresponds to indication state of the first game selecting indicator 70A and the third game selecting indicator 70C shown in FIG. 10. That is, at the time of participation-acceptable-state indication, the above mentioned unacceptable sign is not added there and a color different from a color to be used at the time of participation-unacceptable-state indication is used.

After changing indication of the target game selecting indicator to participation-acceptable-state indication, the console control unit 55 goes on to a processing at S76. In case of not receiving a “participation acceptable signal” (S74: NO), the console control unit 55 goes on to a processing at S76.

At S76, the console control unit 55 judges whether or not a press operation is has been given to a game selecting indicator in accordance with an operation signal from the touch panel 11. That is, the console control unit 55 makes a judgment on S76 by judging whether or not to have received an operation signal from a touch panel 11 corresponding to a game selecting indicator with “participation-acceptable-state indication”. A press operation has been given to a game selecting indicator (S76: YES), the console control unit 55 transmits the central control unit 35 a “participation signal” directed to the pressed game selecting indicator (S77). After transmitting the “participation signal”, the console control unit 55 goes on to a processing at S78. In case a press operation has not been given to a game selecting indicator (S76: NO), the console control unit 55 returns to the processing at S71. That is, a series of processing S71 through S76 is repeated until a game selecting indicator is selected and pressed by the player.

After finishing a series of processing concerning participation in a game (S76: YES, and S77), the console control unit 55 switches the current screen to a wagering screen (not shown) in the liquid crystal display 10. Sequentially, the console control unit 55 judges whether or not a wagering operation has been carried out by a player (S78). To be more specific, the console control unit 55 makes a judgment on S78 by judging whether or not to have received an operation signal from a touch panel 11. In case a wagering operation has been carried out (S78: YES), the console control unit 55 transmits the central control unit 35 wagering information (wagering target and amount of wagering) determined along the wagering operation. In case a wagering operation has not been carried out (S78: NO), the console control unit 55 goes on to a processing at S80.

At S80, the console control unit 50 judges whether or not a participation acceptable period directed to the target game has terminated. The judgment on S80 is made by measuring a period which commences at the time when the console control unit 55 receives a “participation acceptable signal” at S74 with a clock circuit installed in the console control unit 55. In case a participation acceptable period has terminated (S80: YES), the console control unit 55 goes on to a processing at S81. In case a participation acceptable period has not terminated (S80: NO), the console control unit 55 returns to the processing at S78. Thereby, the player can correct or add wagering contents within a participation acceptable period with the target console 4.

At S81, the console control unit 55 judges whether or not to have received “game result” and “payout information” transmitted from the central control unit 35. These “game result” and “payout information” are those what have been determined at the game execution processing (S58) executed by the game control unit 40 directed to a game the target console 4 participates in (S58), and transmitted to the central control unit 35 (S59). The central control unit 35 transmits the “game result” and “payout information” to each console 4 which participates in the game at the game result transmission processing (S18).

In case of receiving the “game result” and “payout information” (S81: YES), the console control unit 55 causes the liquid crystal display 10 to display the “game result” and “payout information” and awards prize in accordance with the “payout information” (S82). In this situation, the player can get payout awarded as prize in a form of coins or, alternatively, stuck the prize in a form of credits by operating the operation buttons 12. After terminating a payout processing (S82), the console control unit 55 returns to the processing at S71. Thereby, game selection screen (see FIG. 10) directed to a next game is displayed, which enables the player to select a game to participate in. In case of not receiving the “game result” and “payout information” (S81: NO), the console control unit 55 stands-by and withholds the processing thereat.

At S81, a game execution processing (S58) is executed at a game control unit 40 directed to a game the target console 4 participates in. That is, in the communal display directed to the target game control unit, there is being displayed contents of the target game (e.g., symbols' varying display and the like in case of slot game). Accordingly, it is also possible to design such that a display control signal is transmitted to the target console 4 so that display contents same as the one in the target communal display can be displayed in the liquid crystal display 10 of the target console 4.

As described, in the gaming machine 1 directed to the first embodiment, the first game through the third game are independently executed by the first game control unit 40A through the third game control unit 40C and displayed in the first communal display 21A through the third communal display 21C, respectively.

Each of the first game, the second game and the third game is independently executed per “unit game” which consists of a “participation acceptable period” and a “game execution period”, and a length of “total necessary time for a game” required for a “unit game” is same regardless of the first game, the second game and the third game. That is, any “participation acceptable periods” and any “game execution periods” are respectively same in length among the first game, the second game and the third game.

When the power is turned on in the gaming machine 1 directed to the first embodiment, a “game execution start signal” is transmitted to the first game control unit 40A (S2). Thereby, the first game control unit 40A commences a participation acceptable period of the first game and sequentially carries out first game related control independently in accordance with the game control processing program. When a first standby period which has commenced along the power-on terminates, a “game execution start signal” is transmitted to the second game control unit 40B (S4). Thereby, the second game control unit 40B commences a second game related participation acceptable period and sequentially carries out second game related control independently in accordance with the game control processing program. Further on, when a predetermined second standby period which has commenced after termination of the first standby period, a “game execution start signal” is transmitted to the third game control unit 40C (S6). The third game control unit 40C commences a third game related participation acceptable period and sequentially carries out third game related control independently in accordance with the game control processing program.

In the gaming machine 1 directed to the first embodiment, the first game, the second game and the third game of which every unit game consists of a same length of total necessary time for a game commence with respectively taking predetermined length of periods (first standby period, second standby period). Accordingly, as shown in FIG. 1, there always exists at least one participation acceptable period directed to any one of the first game, the second game and the third game. Therefore, players can participate in one of games among the first game, the second game and the third game to be executed by the gaming machine 1 at any time. That is, the gaming machine 1 has the convenience to provide players with a chance to participate in a game without waiting for a commencement of a participation acceptable period for long time.

Furthermore, each game control unit transmits a “participation acceptable period start signal” when a participation acceptable period commences, and transmits a “participation acceptable period end signal” when a participation acceptable period terminates. Receiving a “participation acceptable signal” in accordance with a “participation acceptable period start signal” and a “participation acceptable period end signal” in accordance with a “participation unacceptable signal”, each console 4 changes indication state of the first game selecting indicator 70A, the second game selecting indicator 70B and the third game selecting indicator 70C to either “participation-acceptable-state indication” or “participation-unacceptable-state indication”. Such indication manner enables the player to understand whether or not participation in a desired game is possible by just looking at indication state of each game selecting indicator. That is, the gaming machine 1 can realize higher convenience for players to select a game from plural games.

### Second Embodiment

Next, there will be described a gaming machine 1 directed to a second embodiment in detail by referring to drawings. It is to be noted that, in the following descriptions, numerals same as those of the gaming machine 1 directed to the first embodiment are assigned to similar or same structural portions of the gaming machine 1 directed to the second embodiment.

An outline construction of the gaming machine 1 directed to the second embodiment is same as that of the gaming machine 1 directed to the first embodiment. As already described in the first embodiment, there will be omitted the description on the outline construction of the gaming machine 1 directed to the second embodiment, accordingly.

The gaming machine 1 directed to the second embodiment differs from the first embodiment in terms of: game progress manners of the first game, the second game and the third game; and structure of various programs to be executed for the gaming machine 1. Accordingly, there will be described the differences in detail by referring to the drawings.

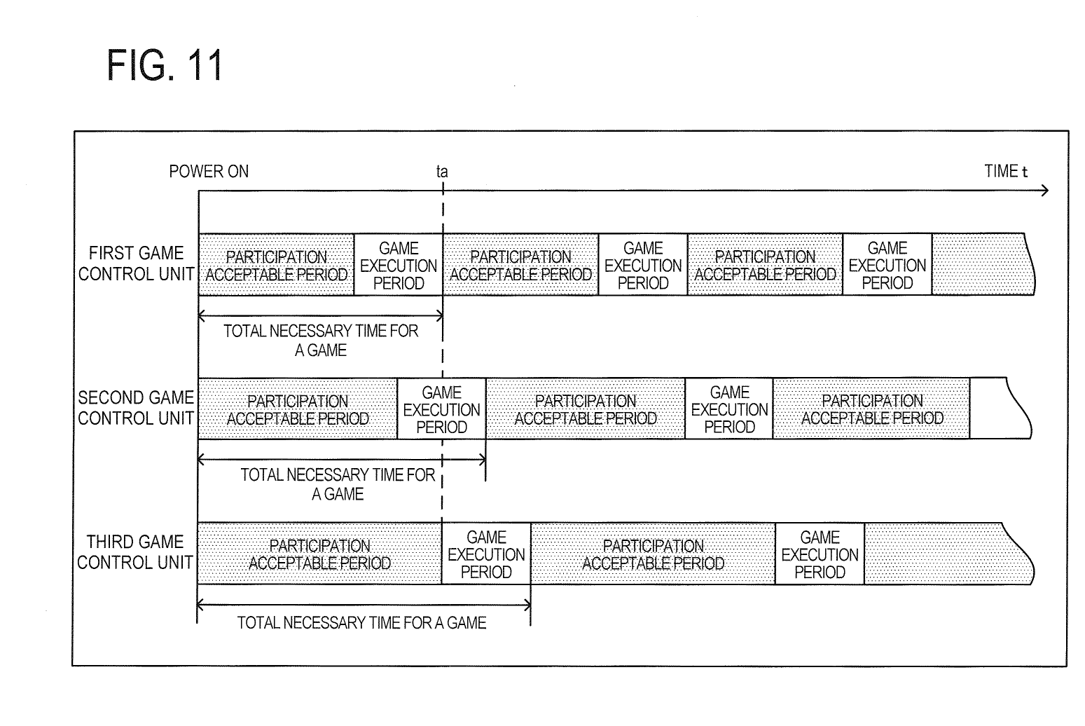

There will be described a feature of a gaming machine 1 directed to the second embodiment. FIG. 11 is a diagram for illustrating the feature of the gaming machine directed to the second embodiment.

Similar to the first embodiment, in the second embodiment, there are provided a first game control unit 40A, a second game control unit 40B and a third game control unit 40C which independently and respectively carry out first game related control, second game related control and third game related control. After terminating a unit game (total necessary time for a game), each of the game control units 40 immediately commences a next unit game. That is, the second embodiment is essentially same as the first embodiment in terms of the point that “each game control unit 40 immediately commences a next participation acceptable period when terminating a game execution period”.

As shown in FIG. 11, different from the first embodiment, a total necessary time for a game scheduled for the first game, that for the second game and that for the third game are made different and longer in the order from the first game, the second game and the third game, in the second embodiment. To be more specific, regarding a participation acceptable period constituting a part of a total necessary time for a game, lengths of respective games' participation acceptable periods are set longer in the order from the first game, the second game and the third game (see FIG. 11)

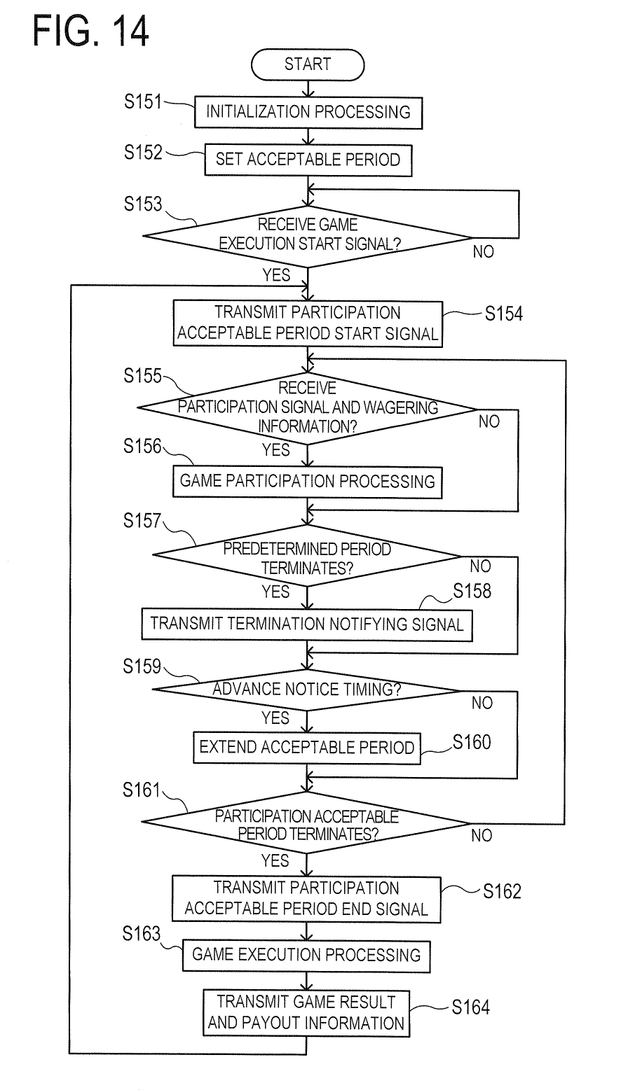

As exemplarily shown in FIG. 11, when the power is turned on to activate the gaming machine 1 of the second embodiment, different from the first embodiment, the first game control unit 40A, the second game control unit 40B and the third game control unit 40C commence a first game related game control processing program, a second game related one, a third game related one simultaneously and respectively (see FIG. 14). In this regard, as described, since the lengths of total necessary time for a game (participation acceptable periods) scheduled to the first game, the second game and the third game are made different, termination timing of a participation acceptable period and that of a total necessary time for a game are also made different among the first game, the second game and the third game.

As shown in FIG. 11, in the second embodiment, a game execution period of the first game is scheduled to terminate at a point in time (ta) where a participation acceptable period of the third game terminates. That is, in the gaming machine 1 directed to the second embodiment, a next participation acceptable period of the first game is commenced in simultaneous with the commencement of a third game related game execution period. That is, in the second embodiment, there exists at least one participation acceptable period directed to any one of the first game, the second game and the third game at the point in time ta.

In this regard, as shown in FIG. 11, the first game control unit 40A, the second game control unit 40B and the third game control unit 40C just independently carry out their respective game related control, whereby it can be controlled such that there always exists at least one participation acceptable period directed to any one of the first game, the second game and the third game. Thus, the gaming machine 1 directed to the second embodiment realizes the convenience to provide players with a chance to participate in a game without waiting for a commencement of a participation acceptable period for long time.

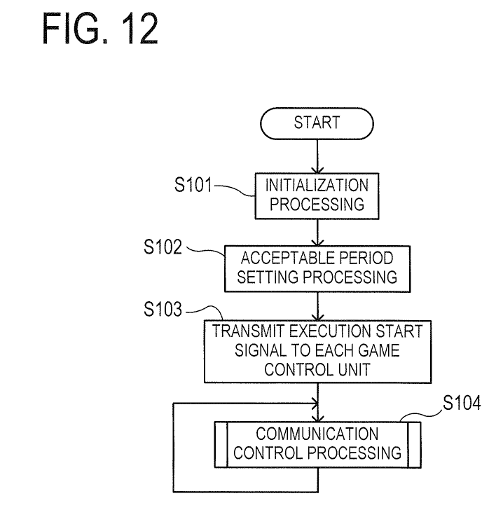

Next, there will be described various control programs to be executed for the gaming machine 1 directed to the second embodiment by referring to drawings. Firstly, there will be described a main control program to be executed by the central control unit 35 directed to the second embodiment. FIG. 12 is a flowchart of the main control processing program to be executed by the gaming machine 1 directed to the second embodiment.

As shown in FIG. 12, when the power of the gaming machine 1 directed to the second embodiment is turned on, the central control unit 35 firstly carries out an initialization processing (S101). The initialization processing (S101) is similar to the initialization processing (S1) directed to the first embodiment. After terminating the initialization processing (S101), the central control unit 35 goes on to a processing at S102.

At S102, the central control unit 35 executes an acceptable period setting processing. At the acceptable period setting processing (S102), the central control unit 35 determines a length of a participation acceptable period with regard to each of the first game, the second game and the third game among three different lengths of the same. In the case shown in FIG. 11, for example, at the acceptable period setting processing (S102), a participation acceptable period of the first game is determined to be the shortest one, that of the second game is determined to be the second shortest one and that of the third game is determined to the longest one. Thus determined lengths of participation acceptable periods are transmitted to corresponding game control units 40 as acceptable period setting data. After transmitting the acceptable period setting data indicating lengths of participation acceptable periods to the corresponding game control units 40, the central control unit 35 goes on to a processing at S103.

At S103, the central control unit 35 transmits an “execution start signal” to each of the first game control unit 40A, the second game control unit 40B and the third game control unit 40C, simultaneously. Similar to the first embodiment, each game control unit 40 commences a unit game related processing (S153) in simultaneous with a receipt of the “execution start signal”. Thereby, in the gaming machine 1 directed to the second embodiment, by executing the processing at S103, initial “participation acceptable periods” of the first game, the second game and the third game are commenced simultaneously (see FIG. 11).

After transmitting the “execution start signal” to each game control unit 40, the central control unit 35 goes on to a communication control processing (S104).

At S104, the central control unit 35 executes the communication control processing. Similar to the communication control processing (S7) directed to the first embodiment, at the communication control processing (S104), various signals and data transmitted from the game control units 40 are transmitted to the target consoles 4, and vice versa, various signals and data transmitted from respective target consoles 4 are transmitted to target game units 40.

After terminating the communication control processing (S104), the central control unit 35 returns to the processing at S104 and executes the communication control processing again.

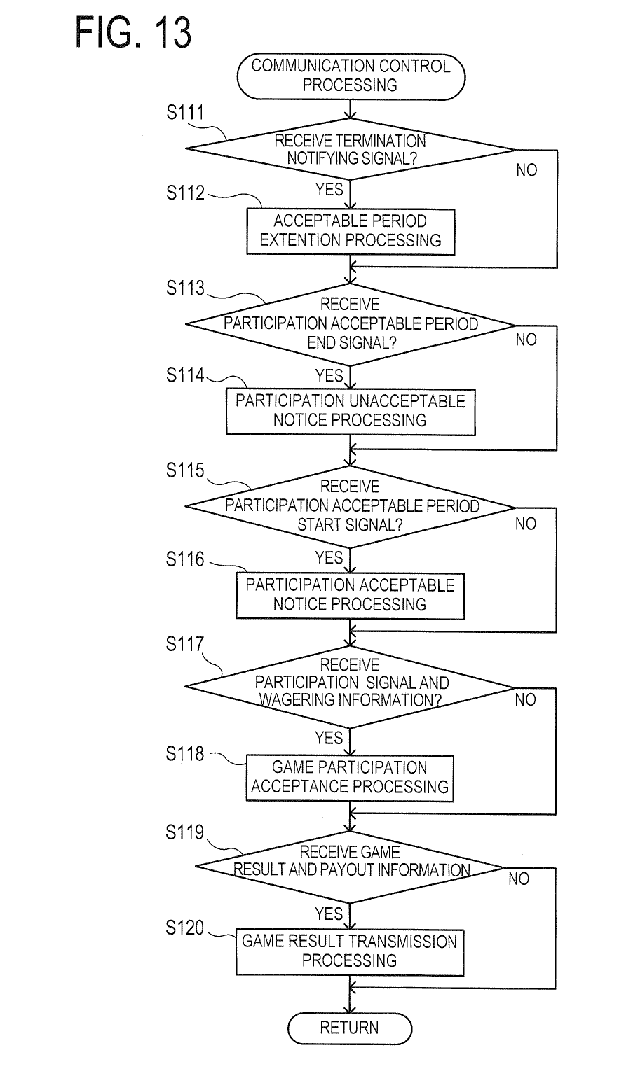

There will be described the communication control processing program to be executed in the communication control processing in detail by referring to drawings. FIG. 13 is a flowchart of the communication control processing program directed to the second embodiment.

At the communication control processing (S104), the central control unit 35 firstly judges whether or not to have received a “termination notifying signal” from each of the game control unit 40 (the first game control unit 40A, the second game control unit 40B and the third game control unit 40C). The “termination notifying signal” is a signal to notify termination timing of a participation acceptable period of a game to be executed by each game control unit 40, and to be transmitted at predetermined timing before termination of the participation acceptable period.

In case of receiving a “termination notifying signal” (S111: YES), the central control unit 35 specifies the point in time to receive the “termination notifying signal, sequentially stores the point in time specified in the RAM 38, and then, goes on to an acceptable period extension processing (S112). In case of not receiving a “termination notifying signal” (S111: NO), the central control unit 35 goes on to a processing at S113.

At S112, the central control unit 35 executes the acceptable period extension processing. At the acceptable period extension processing (S112), a predetermined extension period is added to a participation acceptable period already set for a game which satisfies specific conditions.

To be more specific, the central control unit 35 judges whether or not there are plural games of which participation acceptable periods terminate simultaneously among the first game, the second game and the third game by referring to receipt timing of a latest “termination notifying signal” transmitted from each game control unit 40. In case there are plural games of which participation acceptable periods terminate simultaneously, the central control unit 35 transmits an “extension signal” to a certain game control unit 40 so as to add an extension period to a game of which participation acceptable period is the shortest one. After transmitting an “extension signal”, the central control unit 35 goes on to a processing at S113.

In case there are not plural games of which participation acceptable periods terminate simultaneously, the central control unit 35 terminates the acceptable period extension processing (S112) and goes on to a processing at S113.

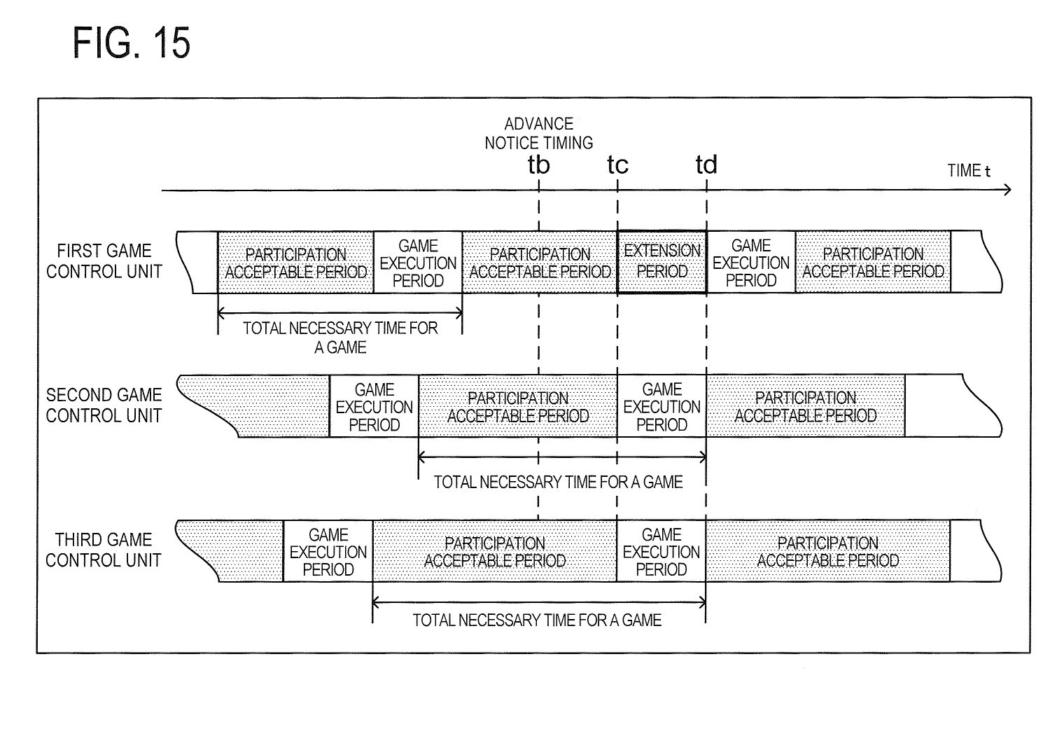

For example, as shown in FIG. 15, in case “termination notifying signals” are transmitted from the first game control unit 40A, the second game control unit 40B and the third game control unit 40C simultaneously at a point in time tb, participation acceptable periods of the first game, the second game and the third game terminate simultaneously at a point in time tc. Accordingly, the central control unit 35 transmits an “extension signal” to the first game control unit 40A of which participation acceptable period is the shortest one. Thereby, an extension period is added to the first game related participation acceptable period (S160). That is, the first game's participation acceptable period is extended to a point in time td.

At S113, the central control unit 35 judges whether or not to have received a “participation acceptable period end signal” transmitted from each game control unit 40.

As shown in FIG. 13, a series of processing S113 through S120 is same as the series of processing S11 through S18 in the communication control processing directed to the first embodiment (see FIG. 7). Accordingly, there will be omitted the description of the series of processing S113 through S120 in the communication control processing directed to the second embodiment.

Next, there will be described a game control processing program to be executed by each game control unit 40 which constitutes a part of the gaming machine 1 directed to the second embodiment by referring to drawings. FIG. 14 is a flowchart of the game control processing program directed to the second embodiment.

When the power of the gaming machine 1 directed to the second embodiment is turned on, an initialization signal is transmitted from the central control unit 35, whereby each game control unit 40 commences an initialization processing (S151). Since this initialization processing (S151) is same as the initialization processing (S51) directed to the first embodiment, detailed description on this processing will be omitted. After terminating the initialization processing (S151), each game control unit 40 goes on to a processing at S152.

At S152, each game control unit 40 sets a length of its participation acceptable period which constitutes a part of each unit game in accordance with acceptable period setting data transmitted from the central control unit 35. For example, in case of FIG. 11, the first game control unit 40A receives “acceptable period setting data” indicating the shortest period at S152 and sets a length of its participation acceptable period directed to the first game in accordance with the acceptable period setting data.

After setting a participation acceptable period in accordance with acceptable period setting data, each game control unit 40 is settled in a standby state and goes on to a processing at S153.

At S153, each game control unit 40 judges whether or not to have received a “game execution start signal” from the central control unit 35. In case of receiving the “game execution start signal” (S153: YES), each game control unit 40 transmits the central control unit 35 an “acceptable period start signal” (S154), and goes on to a processing at S155. In case of not receiving a “game execution start signal” (S153: NO), the game control unit 40 stands-by until receiving a “game execution start signal” from the central control unit 35.

As described, in the second embodiment, a “game execution start signal” is transmitted from the central control unit 35 to each of the first game control unit 40A, the second game control unit 40B and the third game control unit 40C simultaneously (S103). Accordingly, in the second embodiment, each game control unit 40 transmits a “participation acceptable period start signal” to the central control unit 35 (S154) and commences each one's participation acceptable period.

At S155, the game control unit 40 judges whether or not to have received a “participation signal” and “wagering information” from the central control unit 35. In case of receiving a “participation signal” and “wagering information” (S155: YES), the central control unit 35 executes a game participation processing (S156). After terminating the game participation processing (S156), the game control unit 40 goes on to a processing at S157. In case of not receiving the “participation signal” and “wagering information” (S155: NO), the game control unit 40 goes on to the processing at S157 directly.

Since a series of processing S155 and S156 is same as the series of processing S54 and S55 directed to the first embodiment, detailed description of it will be omitted.

At S157, the game control unit 40 judges whether or not there comes advance notice timing. It is to be noted that “advance notice timing” is the timing which comes before termination of a participation acceptable period, and the participation acceptable period is scheduled to terminate when a predetermined length of period lapses from the advance notice timing. Each game control unit 40 judges whether or not there comes “advance notice timing” in accordance with a clock circuit installed in each game control unit 40. In case there comes “advance notice timing” (S157: YES), the target game control unit 40 transmits the central control unit 35 a “termination notifying signal” (S158). After transmitting the “termination notifying signal” to the central control unit 35, the target game control unit 40 goes on to a processing at S159. In case there does not come “advance notice timing” (S157: NO), the target game control unit 40 goes on to a processing at S159.

At S159, the target game control unit 40 judges whether or not to have received an “extension signal”. In case of receiving an “extension signal” (S159: YES), the target game control unit 40 goes on to a processing at S160 so as to add an extension period to a participation acceptable period set at S152 and extends the participation acceptable period (see FIG. 15). After extending the participation acceptable period, the target game control unit 40 goes on to a processing at S161. In case of not receiving the “extension signal” (S159: NO), the target game control unit 40 goes on to a processing at S161 directly.

It is to be noted that an “extension period” added to a participation acceptable period set at S152 is effective only in a current unit game at S160. That is, the target game control unit 40 executes a unit game in accordance with a participation acceptable period set at S152 when going on to a next unit game.

At S161, the target game control unit 40 judges whether or not a participation acceptable period set for each at S152 has terminated. In case the participation acceptable period has terminated (S161: YES), the target game control unit 40 goes on to a processing at S162. In case the participation acceptable period has not terminated (S161: NO), the target game control unit 40 returns to the processing at S155 and repeats a series of processing S155 through S160.

In this connection, in case a participation acceptable period is extended at S160, the game control unit 40 makes judgment on S161 upon termination of the participation acceptable period including “extension period”. Since the judgment processing at S161 is same as the one at S56 directed to the first embodiment, detailed description of it will be omitted.

After that, the game control unit 40 transmits the central control unit 35 a “participation acceptable period end signal” (S162) and sequentially executes a game execution processing (S163). After executing the game execution processing (S163), the game control unit 40 transmits the central control unit 35 a “game result” and “payout information” (S164) and returns to the processing at S154.

Since the series of processing S162 through S164 directed to the second embodiment is same as the series of processing S57 through S59 directed to the first embodiment, detailed description of it will be omitted.

It is not required that the game execution processing (S163) directed to the second embodiment be executed for an equal length of a period at any of the first game control unit 40A, the second control unit 40B and the third game control unit 40C. Furthermore, kinds of game to be executed as the first game, the second game and the third game do not matter as long as it is a game in which determination and report of a game result and determination prize contents in accordance with the game result are carried out within a game execution period. For example, “slot game” is applicable to the first game, the second game and the third game. It is also possible to apply three different games such as “slot game”, “roulette game” and “poker game” to the first game, the second game and the third game.

Similar to the first embodiment, each console 4 directed to the second embodiment is controlled by each console control unit 55. Each console control unit 55 directed to the second embodiment carries out control of the corresponding console 4 in accordance with a main control processing program (see FIG. 9) same as the one directed to the first embodiment. Since the main control processing to be executed by the console control unit 55 has already been described in the first embodiment, the details of it will be omitted.

As described, in the gaming machine 1 directed to the second embodiment, the first game, the second game and the third game are also independently executed by the first game control unit 40A, the second game control unit 40B and the third game control unit 40C and displayed in the first communal display 21A, the second communal display 21B and the third communal display 21C, respectively.

Similar to the first embodiment, each of the first game, the second game and the third game directed to the second embodiment is independently executed per “unit game” which consists of a “participation acceptable period” and a “game execution period”. In this regard, a length of “total necessary time for a game” is different among the first game, the second game and the third game.

To be more specific, in the second embodiment, acceptable period setting data different by game are determined along the processing at S102 executed by the central control unit 35. Further on, a length of a participation acceptable period of each game is determined in accordance with acceptable period setting data determined by each game control unit 40 (S152). Thereby, a “total necessary time for a game” for each of the first game, the second game and the third game is set different in length, as shown in FIG. 11.

When the power is turned on in the gaming machine 1 directed to the second embodiment, a “game execution start signal” is transmitted to each of the first game control unit 40A, the second game control unit 40B and the third game control unit 40C (S103). Thereby, each game control unit 40 commences a participation acceptable period of which length set different by each game control unit 40.

As shown in FIG. 11, each game control unit 40 carries out game related control independently in accordance with a “participation acceptable period” and a “total necessary time for a game” set for each game control unit 40. When a total necessary time for a game set for each game control unit 40 terminates, the game control units 40 commence their respective participation acceptable of next unit games. Accordingly, as shown in FIG. 11, a participation acceptable period of each of the first game, the second game and the third game is made different in termination point in time. Accordingly, the gaming machine 1 directed to the second embodiment can provide players with a chance to participate in a game executed by the gaming machine for a long time. That is, the gaming machine 1 realizes the convenience to provide players with a chance to participate in a game without waiting for a commencement of a participation acceptable period for long time.

Furthermore, in the second embodiment, each game control unit transmits a “participation acceptable period start signal” when a participation acceptable period commences (S154), and transmits a “participation acceptable period end signal” when a participation acceptable period terminates (S162). Receiving a “participation acceptable signal” in accordance with a “participation acceptable period start signal” and a “participation acceptable period end signal” in accordance with a “participation unacceptable signal”, each console 4 changes indication state of the first game selecting indicator 70A, the second game selecting indicator 70B and the third game selecting indicator 70C to either “participation-acceptable-state indication” or “participation-unacceptable-state indication” (S73 and S75). Such indication manner enables the player to understand whether or not participation in a desired game is possible by just looking at indication state of each game selecting indicator. That is, the gaming machine 1 can improve players' convenience when selecting a game from plural games.

Furthermore, regarding the gaming machine 1 directed to the second embodiment, each control unit 40 transmits the central control unit 35 a “termination notifying signal” when “advance notice timing” comes (S158). The central control unit 35 specifies a termination point in time with regard to a participation acceptable period of each of the first game, the second game and the third game in accordance with the “termination notifying signal”. In case participation acceptable periods of plural games terminate simultaneously, the central control unit 35 transmits an “extension signal” to a game control unit 40 which executes a game with a shortest participation acceptable period (S112). The target game control unit 40 extends the participation acceptable period in accordance with the “extension signal (S160).

Thereby, the gaming machine 1 directed to the second embodiment can prevent participation acceptable periods of all of the games from terminating simultaneously. That is, since there is secured the chance to participate in at least one of games, the gaming machine 1 directed to the second embodiment can realizes the convenience to provide players with the chance to participate in a game for long time without waiting for a commencement of a participation acceptable period.

It is to be noted that the present invention is not restricted to the above-described embodiment but, not to mention, it can be variously improved and changed within the scope not departing from the subject matter thereof.

For example, the gaming machine of each embodiment comprises the central control unit 35, the first game control unit 40A, the second game control unit 40B and the third game control unit 40C. However, the gaming machine can go with a single control unit if the single control unit can control and process the first game, the second game and the third game independently.

In each of the embodiments, the gaming machine 1 consists of the communal display device 2 and plural consoles 4. However, the present invention can be embodied in a form of a game system. That is, the present invention can be embodied as a game system which comprises: a server which functions same as the central control unit 35; plural consoles 4; and the communal display device 2 including the first game control unit 40A, the second game control unit 40B and the third game control unit 40C.

Furthermore, in each of the embodiments, the first communal display 21A, the second communal display 21B and the third communal display 21C, the first game control unit 40A, the second game control unit 40B and the third game control unit 40C are installed on the communal display device 2. However, each of the communal displays and each of the game control units 40 may be provided as separate body.

What is claimed is:

1. A gaming machine comprising:
plural communal displays which display unit games each of which including an acceptable period to accept participation in a unit game and an execution period to determine and report a game result after a lapse of the acceptable period;
plural consoles with which operation is carried out for a unit game displayed in any one of the plural communal displays; and
a game controller programmed to operate
(a) to commence acceptable periods of at least two or more of unit games executed in corresponding communal displays with different timing,
(b) to process respective unit games at the plural communal displays independently and
(c) to commence acceptable periods of respective next unit games after execution periods of the respective unit games at the plural communal displays terminate.

2. A gaming machine according to claim 1,
wherein the game controller is further programmed to operate:
(d) to detect termination of acceptable periods of the respective unit games executed by the plural communal displays independently, and
(e) to extend an acceptable period of one of the respective unit games when detecting that acceptable periods of at least two or more of the respective unit games terminate simultaneously.

3. A gaming machine according to claim 1,
wherein each of the plural consoles comprises a display which indicates the respective unit games to be executed at the plural communal displays in form of selecting indicators, and
the game controller controls indication state of the display provided on each of the plural consoles and reports a unit game which is currently in an acceptable period to accept participation.

4. A gaming machine according to claim 2,
wherein each of the plural consoles comprises a display which indicates the respective unit games to be executed at the plural communal displays in form of selecting indicators, and
the game controller controls indication state of the display provided on each of the plural consoles and reports a unit game which is currently in an acceptable period to accept participation.

5. A gaming machine comprising:
plural communal displays which displays unit games each of which is executed for a total necessary time including an acceptable period to accept participation in a unit game and an execution period to determine and report a game result after a lapse of the acceptable period;
plural consoles with which operation is carried out for any one of unit games executed in the plural communal displays; and
a game controller programmed to operate
(a) to commence acceptable periods of at least two or more of unit games executed in corresponding communal displays with different timing,
(b) to process respective unit games at the plural communal displays independently, and
(c) to commence acceptable periods of next unit games after total necessary time, same in length, of the respective unit games at the plural communal displays terminate.

6. A gaming machine according to claim 5,
wherein each of the plural consoles comprises a display which indicates the respective unit games to be executed at the plural communal displays in form of selecting indicators, and
the game controller controls indication state of the display provided on each of the plural consoles and reports a unit game which is currently in an acceptable period to accept participation.

7. A gaming machine comprising:
plural communal displays which displays unit games each of which is executed for a total necessary time including an acceptable period to accept participation in a unit game and an execution period to determine and report a game result after a lapse of the acceptable period;
plural consoles with which operation is carried out for any one of unit games executed in the plural communal displays; and
a game controller programmed to operate
(a) to set total necessary time of at least two or more of unit games executed in corresponding communal displays different in length,
(b) to commence acceptable periods of respective unit games executed by the plural communal displays simultaneously,
(c) to process the respective unit games at the plural communal displays independently, and
(d) to commence acceptable periods of next unit games after execution periods of the respective unit games at the plural communal displays terminate.

8. A gaming machine according to claim 7,
wherein the game controller is further programmed to operate:
(e) to detect termination of acceptable periods of the respective unit games executed by the plural communal displays independently, and
(f) to extend an acceptable period of one of the respective unit games when detecting that acceptable periods of at least two or more of the respective unit games terminate simultaneously.

9. A gaming machine according to claim 7,
wherein each of the plural consoles comprises a display which indicates the respective unit games to be executed at the plural communal displays in form of selecting indicators, and
the game controller controls indication state of the display provided on each of the plural consoles and reports a unit game which is currently in an acceptable period to accept participation.

10. A gaming machine according to claim 9,
wherein the game controller is further programmed to operate:
(e) to detect termination of acceptable periods of the respective unit games executed by the plural communal displays independently, and
(f) to extend an acceptable period of one of the respective unit games when detecting that acceptable periods of at least two or more of the respective unit games terminate simultaneously.
